(19) United States
(12) Patent Application Publication
(10) Pub. No.: US 2025/0156695 A1
(43) Pub. Date: May 15, 2025

(54) SPIKING NEURAL NETWORK APPARATUS

(71) Applicant: Arm Limited, Cambridge (GB)

(72) Inventor: Mbou EYOLE, Cambridge (GB)

(21) Appl. No.: 19/022,483

(22) Filed: Jan. 15, 2025

Related U.S. Application Data
(63) Continuation of application No. PCT/GB2023/051934, filed on Jul. 21, 2023.

(30) Foreign Application Priority Data
Jul. 21, 2022 (GB) 2210712.2

(51) Int. Cl. G06N 3/049

(52) U.S. Cl. CPC G06N 3/049

(57) ABSTRACT

A spiking neural network is described that comprises a plurality of neurons in a first layer connected to at least one neuron in a second layer, each neuron in the first layer being connected to the at least one neuron in the second layer via a respective variable delay path. The at least one neuron in the second layer comprises one or more logic components configured to generate an output signal in dependence upon signals received along the variable delay paths from the plurality of neurons in the first layer. A timing component is configured to determine a timing value in response to receiving the output signal from the one or more logic components, and an accumulate component is configured to accumulate a value based timing values from the timing component. A neuron fires in a case that a value accumulated at the accumulate component reaches a threshold value.

### CROSS-REFERENCE TO RELATED APPLICATIONS

This application is a continuation under 35 U.S.C. § 120 of International Application No. PCT/GB2023/051934, filed Jul. 21, 2023, which claims priority to UK Application No. GB2210712.2, filed Jul. 21, 2022, under 35 U.S.C. § 119 (a). Each of the above-referenced patent applications is incorporated by reference in their entireties.

### TECHNICAL FIELD

The present invention relates to spiking neural network apparatus and a method of training a neural network on such apparatus.

### BACKGROUND

Spiking neural network apparatus provide a potential means to address efficiency challenges of conventional machine learning systems. By designing electronic component to follow—so far as is possible—biological neurons and neuronal architecture, energy-efficiency of machine learning systems may be considerably improved. Spiking neural network apparatus benefit from their event-driven nature-computation occurring only as necessary confers substantial advantages in efficiency.

Previous solutions provided in the art have relied on weights encoded in SRAM storage in order to generate values at neurons within a spiking neural network apparatus. This reduces the efficiency advantages of spiking neural network apparatus relative to processing of conventional neural networks, as there is still a need to retrieve network weights from storage, which consumes both power and computational resources. Additionally, previous solutions have utilised Analog-to-Digital Converter (ADC) hardware blocks, for converting values of ‘spikes’ in the network into the digital domain in order to operate on this information with the stored weights, before using Digital-to-Analog Converter (DAC) hardware blocks to reverse this process in order to perform sampling operations to fire an output ‘pulse.’ This too reduces the efficiency advantages of a spiking neural network apparatus, as well as imposing greater financial costs.

Training of neural networks on spiking neural network apparatus may also be challenging. The spikes produced by such spiking neural network apparatus are by nature non-differentiable and consequently conventional training algorithms such as back-propagation may not be applicable.

In view of these requirements, an improved design of spiking neural network apparatus, and a method of training neural networks on such improved spiking neural network apparatus, is desirable.

### SUMMARY

According to a first aspect of the present invention, there is provided a spiking neural network apparatus comprising a plurality of neurons, each neuron of the plurality of neurons having an input comprising a plurality of variable delay paths, and wherein each neuron of the plurality of neurons comprises: one or more logic components connected to the plurality of delay paths, the logic component configured to generate an output signal in dependence upon signals received along the variable delay paths; a timing component configured to determine a timing value in response to receiving the output signal from the one or more logic components; and an accumulate component configured to accumulate a value based on one or more determined timing values from the timing component, wherein each neuron is configured to generate an output signal in a case that a value accumulated at the accumulate component reaches a threshold value.

According to a second aspect of the present invention there is provided a method of training a neural network on a spiking neural network apparatus according to the first aspect of the present invention, the method comprising: presenting the spiking neural network apparatus with test input data; selecting, a single neuron from a first layer of the network; defining a set of neurons from the first layer as sleeper neurons, which set of neurons does not include the selected neuron; determining whether the selected neuron has an activation state that is in conformity with an expected output of the neural network; and adjusting a delay value of at least one input variable delay path that inputs to the selected neuron.

According to a third aspect of the present invention there is provided: a method of executing neural network data using a spiking neural network apparatus the method comprising: presenting the spiking neural network apparatus with data to be processed; generating an input signal based on the data to be processed; processing the input signal through the spiking neural network including, for a plurality of neurons, the steps of: sending spike signals along a plurality of delay paths of the input of the plurality of neurons, a logic component of each neuron generating an output signal in dependence upon the spike signals received along the variable delay paths, a timing component of each neuron determining a timing value in response to receiving an output signal from the one or more logical components, and an accumulate component of each neuron accumulating a value based on one or more determined timing values, and generating an output signal in a case that the value accumulated at the neuron reaches a threshold value.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram showing an example of the architecture of a spiking neural network apparatus.

FIG. 2 is a schematic diagram showing the structure of a synaptic delay path.

FIG. 3 is a schematic diagram showing the structure of a neuron within a spiking neural network apparatus.

FIG. 4 is a flowchart illustrating the steps of a method of training a spiking neural network.

FIG. 4A is a schematic diagram showing an exemplary set of delay paths during the training of a neural network.

FIG. 5 is a schematic diagram showing an alternative embodiment wherein each neuron is provided with multiple input delay paths.

### DETAILED DESCRIPTION

Before discussing particular embodiments with reference to the accompanying figures, the following description of embodiments is provided.

A first embodiment describes a spiking neural network apparatus comprising a plurality of neurons, each neuron of the plurality of neurons having an input comprising a plurality of variable delay paths, and wherein each neuron of the plurality of neurons comprises: one or more logic components connected to the plurality of delay paths, the logic component configured to generate an output signal in dependence upon signals received along the variable delay paths; a timing component configured to determine a timing value in response to receiving the output signal from the one or more logic components; and an accumulate component configured to accumulate a value based on one or more determined timing values from the timing component, wherein each neuron is configured to generate an output signal in a case that a value accumulated at the accumulate component reaches a threshold value.

In some embodiments the neuron generating an output signal causes the neuron to send an electrical signal onto at least one output variable delay path. In other implementations, the spiking neural network apparatus may be configured so that generating an output signal causes another neuron in the spiking neural network apparatus to send an electrical signal onto at least one output variable delay path. The output signal may be stored in a storage. The stored output signal may be readout at a later time for additional processing of a neural network. Such configurations may allow the spiking neural network apparatus to sequentially perform calculations for different parts of a neural network.

Each variable delay path may comprise at least one of: an inverter, a capacitor, and a variable resistor. The variable resistor may comprise at least one of: a resistive RAM device; a correlated-electron RAM device; and a ferroelectric RAM device. The logic component may comprise a NAND gate, which may have a high fan-in. The at least one logic component may alternatively comprise a stack of NAND gates.

The timing component may comprise a flip-flop connected to a timing signal. The timing signal may be carried on a timing line. The timing signal configured to reset a timing value at the start of an epoch. The accumulator component may also be configured to reset at the start of any epoch. The timing component may be configured to determine a timing value that is in a gray code cyclic format. The at least one neuron in the second layer may further comprise popcount hardware.

Each variable delay path of the plurality of variable delay paths may further comprise a plurality of variable resistors arranged in parallel. At least one pass transistor may be connected in series with each variable resistor. The at least one pass transistor may be configured to receive a phase signal associated with a different portion of a dataflow graph of a neural network.

The output signal generated by at least one neuron of the plurality of neurons may be stored in a memory element of the spiking neural network apparatus. The memory element may be configured to store the output signal so that the output signal can be released along a variable delay path of the plurality of variable delay paths at a later time. The output signal may be transmitted along a variable delay path of the plurality of variable delay paths to arrive at the logic component of the same neuron.

According to a second embodiment, there is provided a method of training a neural network on a spiking neural network apparatus according to the first embodiment, the method comprising: presenting the spiking neural network apparatus with test input data; selecting, a single neuron from a first layer of the network; defining a set of neurons from the first layer as sleeper neurons, which set of neurons does not include the selected neuron; determining whether the selected neuron has an activation state that is in conformity with an expected output of the neural network; and adjusting a delay value of at least one input variable delay path that inputs to the selected neuron. Determining whether the selected neuron has an activation state that is in conformity with an expected output may comprise processing other layers of the neural network with a current set of delay values of associated variable delay paths with the selected node firing; processing other layers of the neural network with a current set of delay values of associated variable delay paths with the selected node not firing; and comparing an output of the spiking neural network in each case against an expected activation.

Adjusting the delay value of the variable delay path associated with the selected neuron associated with the selected neuron may comprise identifying a sleeper neuron among the sleeper neurons that has an accumulated value that is closest to becoming activated or closest to becoming deactivated; defining a difference between an accumulated value for the selected neuron and the accumulated value for the identified sleeper neuron; determining differences by making small changes to delay values on each input delay path to the selected neuron; and adjusting the delay value of at least one input variable delay path based at least in part on the determined differences. Adjusting the delay value of at least one input variable delay path may be based at least in part on a predetermined learning rate parameter.

Adjusting the delay value may comprise one of: reducing the delay value of the associated variable delay path by reducing the resistance value of the at least one variable resistor within the variable delay path; and increasing the delay value of the associated variable delay path by increasing the resistance value of the at least one variable resistor within the variable delay path. Adjusting the delay value may further comprise adjusting the delay value of at least one additional input variable delay path according to a dither pattern.

Selecting a neuron from the first layer of the neural network may comprise one of: selecting a neuron at random and selecting a neuron according to a predetermined search pattern. The method of training may additionally comprise reducing the learning rate over time.

According to a third embodiment there is provided a method of executing neural network data using a spiking neural network apparatus the method comprising: presenting the spiking neural network apparatus with data to be processed; generating an input signal based on the data to be processed; processing the input signal through the spiking neural network including, for a plurality of neurons, the steps of: sending spike signals along a plurality of delay paths of the input of the plurality of neurons, a logic component of each neuron generating an output signal in dependence upon the spike signals received along the variable delay paths, a timing component of each neuron determining a timing value in response to receiving an output signal from the one or more logical components, and an accumulate component of each neuron accumulating a value based on one or more determined timing values, and generating an output signal in a case that the value accumulated at the neuron reaches a threshold value.

The spiking neural network apparatus may comprise a spiking neural network apparatus as described in connection with the first embodiment.

According to a further embodiment, there is provided a spiking neural network apparatus comprising a plurality of neurons in a first layer connected to at least one neuron in a second layer, each neuron in the first layer being connected to the at least one neuron in the second layer via a respective variable delay path, wherein the at least one neuron in the second layer comprises: one or more logic components connected to each delay path from the plurality of neurons in the first layer, the logic component configured to generate an output signal in dependence upon signals received along the variable delay paths from the plurality of neurons in the first layer; a timing component configured to determine a timing value in response to receiving the output signal from the one or more logic components; and an accumulate component configured to accumulate a value based on one or more determined timing values from the timing component, wherein each neuron is configured to fire in a case that a value accumulated at the accumulate component reaches a threshold value.

Particular embodiments will now be described, with reference to the figures.

Spiking neural networks are neural networks that attempt to more closely mimic a biological neural network than conventional neural networks. Instead of working with numerical values processed through layers of weights in the neural network, spiking neural networks operate with discrete events occurring at specific points in time. In order to perform inference on a given set of data, the spiking neural network is presented with data to be processed. An input signal is generated from the data to be processed—this input signal takes the form of a pattern of ‘spikes’ of voltage, or pulses. The input signal is provided to a set of neurons that make up the input layer of the neural network. Each of these neurons, if the input signal requires the neuron to fire, send an output pulse on each output delay path associated with that neuron in response. Each neuron in subsequent layers receives pulses, generates a value based on the received pulses, and determines whether to fire. The signals propagate through the neural network in this way—the pulses from each neuron are transmitted along delay paths to arrive at neurons in a subsequent layer, which generate output pulses in turn. When the final layer is reached, the neural network outputs an output signal. This output signal may then be used to generate output data corresponding to the initial inference data.

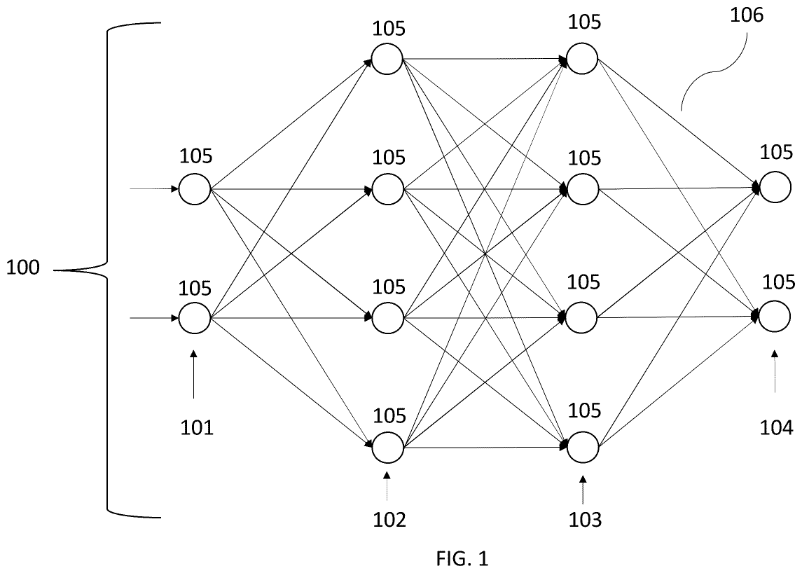

FIG. 1 provides an illustration of a broad overview of a neural network apparatus upon which a spiking neural network may be implemented. The skilled person will appreciate that the example shown is presented by way of example and not limitation, and that alternative architectures may be used.

Spiking neural network 106 is implemented on spiking neural network apparatus 100. Spiking neural network apparatus 100 consists of a plurality of layers 101, 102, 103 and 104. Each layer is composed of a plurality of neurons 105. Each neuron 105 has an internal state that may be referred to as a membrane potential. Each neuron 105 then receives, as an input, a ‘spike’ or pulse which may be provided as an initial input (in the case of input layer 101) or which may be generated as the output of a neuron in a previous layer (in the cases of layers 102 and 103). The input pulse may cause the modelled membrane potential of neuron 105 to rise. Encoding schemes may be used to interpret the pulse as a numerical value-according to one embodiment of the present invention, the time at which the pulse arrives at the recipient neuron may be used to generate this value.

The processing of each layer 101, 102 or 103 is initiated synchronously, by launching all spikes from neurons that have fired within that layer at the same time—i.e. each neuron for which the conditions are met to generate an output pulse will generate that pulse at the same time.

In one embodiment of the present invention, every neuron 105 in a given layer 101 is connected to every neuron in the subsequent layer 102. Other architectures may be implemented in alternative embodiments. The neurons are connected by synaptic delay paths. These paths are used to modify the arrival time of a pulse generated by a neuron 105 in a preceding layer by neurons 105 in the next layer. For example, arrival of a pulse from a neuron 105 in the first layer 101 at a neuron 105 in a second layer 102 may be delayed by a variable amount. The delays between given neurons provided by synaptic delay paths are used to encode the weights of the neural network.

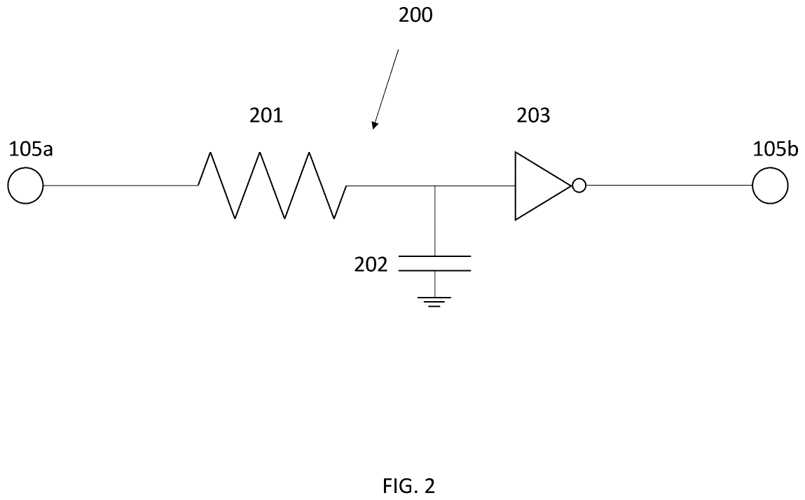

FIG. 2 is a schematic diagram showing an exemplary structure of a synaptic delay path 200 of a type that could be used to implement a spiking neural network as described in relation to FIG. 1. Delay path 200 connects first neuron 105a and second neuron 105b, and consists of a variable resistor 201, a capacitor 202, and an inverter 203. Synaptic delay path 200 may be used to modify the arrival time of a pulse generated by neuron 105a at neuron 105b by a variable amount. This variable amount may be modified by altering the value of variable resistor 201. By varying the resistance of variable resistor 201, the resistance of synaptic delay path 200 overall may be increased, which may increase the time taken for a pulse to traverse the entire path.

Variable resistor 201 may be a variable NVRAM resistor. Such resistors may be capable of multiple discrete resistance values—i.e. multiple current-voltage profiles. As an NVRAM device is by nature non-volatile, weights derived from training—which may be encoded as resistance values—do not need to be streamed in or out of computational units. Once the NVRAM device is active, the resistance values are permanently accessible. This improves the computational efficiency of the system, as the streaming step may be eliminated. This also confers substantial power-saving benefits, as the weights/resistance values do not need to be moved. In some embodiments, the NVRAM device used to implement variable resistor 201 may be capable of multi-level storage. In such embodiments, each NVRAM cell may be programmed to store multi-bit values, by leveraging alternative configurations of its physical state.

According to a first embodiment, the NVRAM device used to implement variable resistor 201 may be a Correlated-electron Random Access Memory (CeRAM) device. CeRAM devices may be formed by sandwiching a transition-metal-oxide (TMO) between metal layers. CeRAM devices may undergo phase changes that change their physical (material) and electrical properties when certain voltages and currents are applied. CeRAM devices are significantly denser than some other forms of RAM, such as Static RAM (SRAM). The increased density of CeRAM devices means that the total area required for spiking neural network apparatus 100 is reduced when CeRAM devices are utilised to implement variable resistor 201, compared to the use of (for example) SRAM devices. While the use of a CeRAM device has been described here, in other embodiments, the NVRAM resistor may be at least one of a resistive RAM (ReRAM) device or ferroelectric RAM device. The skilled person will appreciate that similar power savings, efficiency increases, and reduced area advantages will be conferred through the use of these devices as through the use of a CeRAM device.

The delay experienced along synaptic display path 200 is governed by the following equation:

τ=αRC
where τ is the delay experienced, R is the resistance of variable resistor 201, C is the capacitance of capacitor 202, and α is a constant dependent upon the noise margin of inverter 203.

The skilled person will appreciate that, while not shown in the present figure, the weights corresponding to a given layer of spiking neural network 106 may be pre-programmed into variable resistor 201 by additional circuitry capable of controlling the currents and voltages seen by the resistor.

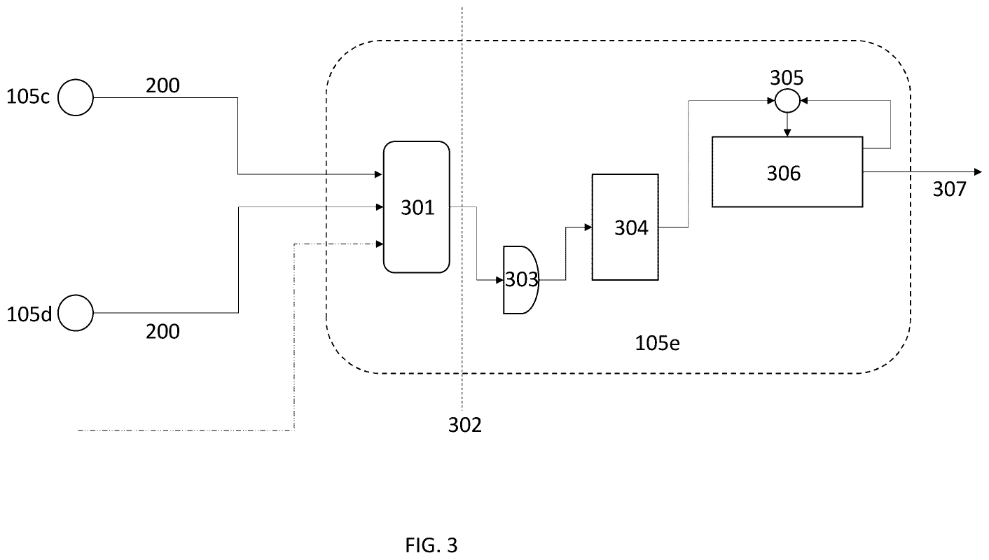

FIG. 3 is a schematic diagram of an example of a neuron 105e within spiking neural network apparatus 100. Pulses are generated by neurons 105c and 105d in a preceding layer, and are passed along synaptic delay paths 200, of the type shown in FIG. 2. The skilled person will appreciate that the number of pulses received will depend on the number of neurons in the previous layer of spiking neural network apparatus 100, and that the number of input delay paths shown in FIG. 3 is provided by way of example and not limitation.

Upon arriving at neuron 105e—after the delay implemented by synaptic delay paths 200—the pulses may enter neuron 105e through logic gate 301. Logic gate 301 may be a NAND gate, and may have a high fan-in, in order to be able to handle a high number of input pulses, especially in larger spiking neural networks. According to some embodiments, logic gate 301 may comprise a hierarchy of logic gates. Logic gate 301 may operate to combine inverted pulses, delayed by synaptic delay paths 200, arriving from the preceding neurons 105c and 105d.

Logic gate 301 may, upon receiving an input pulse from a preceding neuron 105, output a clock enable signal. This clock enable signal activates a clock component 303, which may register a value based on a timing signal 302 from a timing signal line. The timing signal line 302 may be connected to all neurons 105 within a given layer 102 of spiking neural network 106—thus all neurons in a given layer will share a common time base. According to some embodiments, the timing signal 302 transmitted on the timing signal line may be encoded in a gray code cyclic format—this format means that only one bit value of timing signal 302 changes at a time, which reduces the power requirement to enable it. The state of timing signal 302 may be reset at the start of any processing epoch within a layer of spiking neural network 106. That is to say that the spikes may be released from layers of the spiking neural network according to epochs and the timing signal 302 may be reset or cycled to control the release of the pulses.

Clock component 303 and timing signal 302 may be connected to flip-flop 304. Flip-flop 304 may register a value based on timing signal 302 and clock component 303. According to some embodiments, the value registered by flip-flop 304 may correspond to the value of timing signal 302 at the time that the clock enable signal is received. The value of the timing signal may increase during an epoch—i.e. the longer the interval between an initialisation of timing signal 302 and the receiving of a pulse from preceding neuron 105, the higher the value recorded by flip-flop 304.

The value registered by flip-flop 304 may then be passed to accumulator component 305. The value may be passed to an accumulation (ACC) register 306 for storage. If values are already stored in ACC register 306, the stored values will, upon receipt of a new value from the flip-flop 304, be passed to accumulator component 305. The new value registered by flip-flop 304 will be summed with the stored values from ACC register 306 by accumulator component 305. The new value will then be stored in the ACC register 306. The value stored in the ACC register may be considered to correspond to a modelling of the membrane potential described earlier.

When a value stored in the ACC register 306 exceeds a threshold value or an overflow condition is detected based on the value accumulated and held in ACC register 306, the neuron 105e ‘fires.’ This triggers the transmission of a new pulse from neuron 105e to a neuron in the subsequent layer, through output 307. As stated previously, the firing of a neuron does not immediately mean that a ‘spike’ or pulse is transmitted-all spikes from neurons that have fired within a given layer will be transmitted at the same time. ACC register 306 may also be reset at the start of any processing epoch within a layer of spiking neural network 106.

In embodiments wherein timing signal 302 is encoded in a gray code cyclic format, accumulator component 305 and ACC register 306 may both be augmented to enable the processing of gray code encoded values and the triggering of a new spike upon occurrence of an overflow condition.

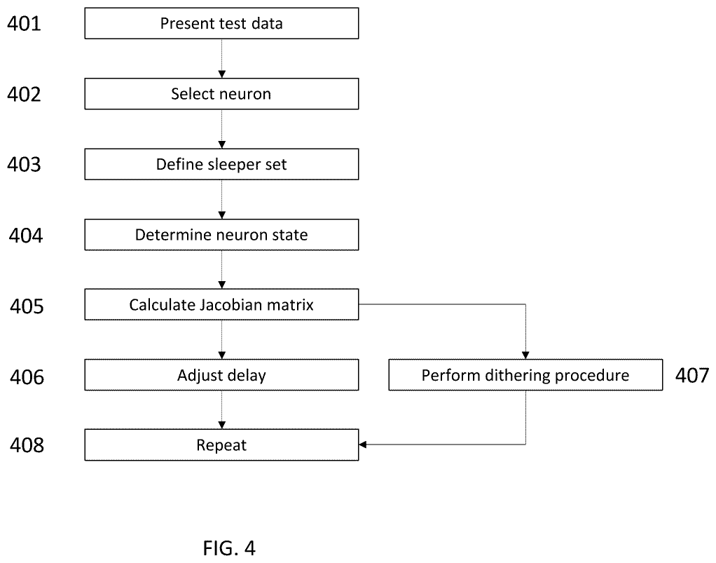

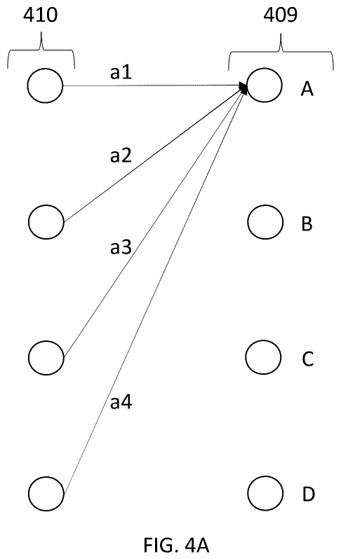

FIG. 4 is a flow chart illustrating an exemplary process by which a neural network may be trained using a spiking neural network apparatus as described in relation to the preceding figures. There is currently no widely-accepted or standard methodology for training spiking neural networks. Spikes produced by neurons are not differentiable, thus conventional training algorithms such as back-propagation may not be easily applicable.

At step 401, test data may be presented to spiking neural network 106. This test data is then processed by spiking neural network apparatus 100 to produce a test output. The desired output is known, allowing the output produced for a given set of test data to be compared to the desired output. In other words, the following method describes a supervised learning process.

At step 402, a neuron is selected from a single layer of the neural network 106 being trained and the corresponding neuron on spiking neural network apparatus 100 is identified. This selection of the neuron within the layer is made at random. The selected neuron will be the only neuron in a given training cycle for which any adjustment of weights will be made. The selection of the neuron may be performed at random or in accordance with a search pattern. By successively selecting neurons in different parts of the neural network apparatus 100 to adjust, the spiking neural network 106 is less likely to become unable to progress beyond a local optimum solution and the training method tends to search the space of weight values more generally.

At step 403, a sleeper set of neurons is defined. This sleeper set of neurons encompasses some or all other neurons in the given layer, excluding the neuron selected in step 402.

At step 403, the activation of the selected neuron may be examined, to determine whether the neuron in question has activated in accordance with the expected output. In this step, it is determined whether, given a particular expected output for the training data input, the selected neuron should have fired a pulse, and whether it did fire a pulse. In one embodiment, determining whether or not the selected neuron should have fired may be determined by processing the remaining layers of the neural network, based on the current set of weight values in the training process, both with the selected node firing and the selected node not firing. By comparing the outputs of the spiking neural network in each case against the expected activation (because the training is supervised learning with an expected output), it can be determined whether or not activation of the neuron 105 is in accordance with the expected output. In other embodiments, other approaches may be considered. In one alternative approach, the firing state of all neurons in a layer under consideration may be recorded, and the accuracy of the final output of the neural network may be determined. If the final output is accurate, the neurons that have fired have done so correctly-if the output is inaccurate, the neurons that have fired have done so incorrectly.

At step 404, a Jacobian matrix is computed. This Jacobian matrix may be computed in different manners dependent upon whether the selected neuron activated correctly or incorrectly relative to the expected output. If the selected neuron activated correctly relative to the expected output, the Jacobian matrix may be determined by maximising the difference between the output of the selected neuron and the output of the neuron within the sleeper set that is not activated but with the highest probability of becoming activated. If the selected neuron activated incorrectly relative to the expected output, the Jacobian matrix may be determined by minimising the difference between the output of the selected neuron and the output of the neuron within the sleeper set that is not activated but with the highest probability of becoming activated.

This step may be explained in greater detail with the assistance of FIG. 4A. In FIG. 4A, neurons within spiking neural network apparatus 100 corresponding to two layers of spiking neural network 106 are shown, each layer comprising four neurons. Layer 409 is the layer containing the neuron selected for training, neuron A. Neurons B, C and D comprise the sleeper set for layer 409. Layer 410 is the preceding layer, from which pulses are fired to be received by layer 409.

Neuron A has four input delay paths from preceding layer 410, labelled as a1-a4. The skilled person will appreciate that neurons B, C and D each have four corresponding input delay paths, and that these have been omitted from FIG. 4A in the interests of clarity, not to limit the disclosure of FIG. 4A. It is assumed that all neurons in layer 409 have identical threshold values—for the sake of example, it will be assumed that the timing signal and accumulator values may be represented in base 10, and that the threshold value for the neuron to fire is 5. The skilled person will appreciate that all values used herein are used for exemplary purposes only and are intended solely for illustration. The values used should not be construed as limiting the present disclosure to only those values, numerical systems and bases utilised herein.

If it is assumed that the firing threshold for neurons in layer 409 is 5, in this example neuron A has fired with accumulator value 7. Neuron B may be considered the neuron within the sleeper set that is not activated but with the next-highest probability of firing, with an accumulator value of 4.

If the firing of neuron A is desirable—i.e. neuron A has activated correctly relative to the expected output—the difference between neuron A and neuron B should be maximised. This means that A-B should be as large as possible, driving the accumulated value (or membrane potential) of neuron A higher. The following Jacobian matrix may be determined:

$$\frac{dA - B}{a 1} , \frac{dA - B}{a 2} , \frac{dA - B}{a 3} , \frac{dA - B}{a 4}$$

These values are determined by selectively adjusting the resistance values on each of the delay lines in turn and processing the neural network on the test data item in order to identify how the change in the resistance value on each delay line affects the value A-B.

Returning to FIG. 4, at step 405 the Jacobian matrix calculated at step 404, as described in relation to FIG. 4A, may be used as a basis to adjust the delays of the synaptic delay paths leading into the selected neuron—an appropriate learning rate parameter may also form part of the basis for adjusting the delays, to ensure that the adjustments made are neither so large and unconstrained that the network becomes chaotic, nor so small that the process is unduly delayed. The skilled person will appreciate that such an appropriate learning rate may depend on the situation and may be reached by iterative trial-and-error, but that heuristics or guidelines developed through experience may be utilised to assist this process. Depending on whether the neuron has activated correctly or incorrectly relative to the expected output, the values of one or more delay paths may be adjusted to either increase or decrease the accumulator value of the selected neuron. The delays of the synaptic delay paths may be increased or decrease by increasing or decreasing the resistance of the variable resistor of the relevant path respectively.

As stated previously, the weights of spiking neural network 106 are encoded as the delays of the synaptic delay paths—by adjusting the delays of the synaptic delay paths, the weights of spiking neural network 106 are thereby also adjusted. The adjustments made to the weights (thus also to the resistance values and delay values) will be small. As the training proceeds, the learning rate may be reduced, in order to encourage stability of spiking neural network 106.

According to some embodiments, in step 407, a dithering procedure may be performed. The use of a dithering procedure is not essential but may be implemented as appropriate.

Use of a dithering procedure may be useful due to the potentially high fan-in into logic gate 301. In an example of spiking neural network 106 implemented on spiking neural network apparatus 100. where the number of neurons in a given layer—and thus the number of neurons feeding into each neuron of a subsequent layer—is high, there is a chance (though small) that multiple signals from the preceding layer may arrive at the recipient neuron at exactly the same time. In such situations, information will be lost, as only a single bit of information will be passed to clock element 303.

Applying a dithering procedure comprises, in parallel to the updating of the weights of a given neuron, applying small random changes to all of the weights. This encourages jitter in the time domain, reducing the likelihood that multiple pulses from preceding neurons will arrive simultaneously. According to alternative embodiments, ‘popcount’ (Population Count) hardware, or a suitable alternative thereto, may be used to address the pulse collision problem.

At step 408, the process described above is repeated—another neuron is selected at random, and the training process is conducted for that neuron. The method may be repeated by selecting each layer of the neural network in turn and selecting a neuron at random from that layer. In other implementations, at each layer, neurons may be selected at random until all neurons in the given layer have been adjusted and then a next layer may be selected.

The above method operates on the principle that if the neural network responded correctly then the method takes actions to make that outcome more likely in future, for example, by increasing the relative strength of the connection between neurons if the neuron “fired” or decreasing the relative strength of the connection between neurons if the neuron did not “fire”. If the neural network responded incorrectly then the method takes actions to make that outcome less likely in future, for example, by decreasing the relative strength of the connection between neurons if the neuron “fired” or increasing the relative strength of the connection between neurons if the neuron did not “fire”. The term “relative” refers to the splitting of the group of neurons into an “active” set and a “sleeper” set. The “active” or “randomly selected” neurons are the neurons under test whose forward connections are updated. The method algorithm tends to reward or penalize the connections between neurons by amounts which depend on the perceived difference between the “active” and the “sleeper” set. This enables a subsequent neural network layer which observes neuronal firings from the preceding layer to be better able to discern between outcomes.

### Further Embodiment—Improved Network Density

According to a further embodiment of the present invention, a first neuron 105 and a second neuron 105 may be connected by a synaptic delay pathway comprising more than one variable resistor. This configuration may allow a single synaptic delay pathway to be utilised in different configurations—the density of circuitry required for spiking neural network apparatus 100 may therefore be increased, reducing the overall area required.

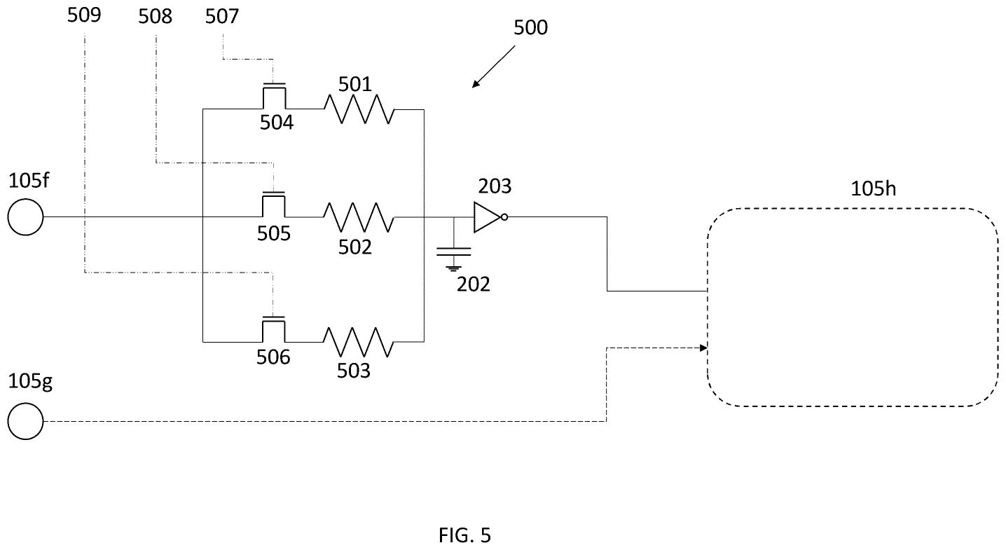

FIG. 5 is a schematic illustration of this further embodiment. Neuron 105f is connected to neuron 105h by a path 500. All neurons illustrated in this figure may comprise the same circuitry as described in connection with previous embodiments and illustrated in FIG. 3. The path 500 comprises a plurality of pathways, each pathway containing a variable resistor 501 to 503.

When a pulse is to be emitted from neuron 105f, pass transistors 504, 505 and 506 may be used to determine which pathway is selected to transmit the pulse to neuron 105h. This determination is made in accordance with phase signals 507, 508 and 509, which are passed to pass transistors 504, 505 and 506. Variable resistors 501, 502 and 503 may be set to different resistance values, thus the delay between the different pathways will vary. In this manner, the connection between neurons 105f and 105h may be selectively controlled to have any of three different weights applied at different times.

Phase signals 507, 508 and 509 may each be associated with a different portion of a dataflow graph of spiking neural network 106. By enabling different pathways at different times, each with a different delay—or weight—the recipient neuron 105h may be thought of as being a component neuron of multiple layers.

By way of example, the processing of data using the circuitry shown in FIG. 5 may be considered at three different points in time. At a first point in time, phase signal 507 may trigger pass transistor 504, completing a first path. A pulse fired from neuron 105f at this first time would therefore pass through variable resistor 501. A first delay would then be applied, and the arrival of the pulse at neuron 105h would register a first value, with neuron 105h then firing in due course.

At a second point in time, later during the processing of the same input data set, phase signal 508 may trigger pass transistor 505, completing a second delay path. A pulse fired from neuron 105f at this second time would then pass through variable resistor 502. A second delay would then be applied, and the arrival of the pulse at neuron 105h would register a second value, with neuron 105h then firing in due course. The skilled person will appreciate that this same process may later occur at a third point in time for the third path through variable resistor 503.

This embodiment therefore allows for multiple different values to be registered by a pulse firing from neuron 105f and arriving at neuron 105h. In the exemplary embodiment of FIG. 5, the circuitry of neuron 105f may be used to generate three different values. In this way, this embodiment effectively permits a single hardware instance to function as three neurons. Instead of requiring an entire additional set of neuron hardware (such as the logic gate, flip-flop, accumulator et cetera) as well as a new delay path, the only additional components required here to implement a further neuron are a further variable resistor and a pass transistor—these are comparatively low-area additions. This effect is increased by the density of the NVRAM resistor devices used in this invention, as discussed previously.

By allowing the use of the same circuitry on an iterative basis to model the entire network, the density of the network may be improved, and the area required to implement the network is greatly reduced.

A further neuron 105g is shown in FIG. 5 and, although not illustrated, this neuron may be configured in the same way as neuron 105f with phase signals and pass transistors. Further neurons may be added to increase the number of inputs to neuron 105h.

This embodiment permits a spiking neural network to be enabled in such a way that there is not a one to one correspondence between the hardware units—i.e. the physically-implemented neurons—and neurons in the dataflow graph of the spiking neural network. By way of illustration, a neural network may be considered wherein four hardware units implement a spiking neural network having three layers each comprising eight neurons. Each hardware unit may, in such an example, be used to implement six neurons in the dataflow graph. However, as there are more neurons per layer than there are hardware instances, in order for all neurons in a given layer to fire at the same time (as detailed above), the pulse fired from at least some of the hardware instances must be stored in a memory element of the spiking neural network apparatus, to be released along a variable delay path at the appropriate time so that the processing of the layer can be initiated synchronously, as described above in connection with FIG. 1.

The person skilled in the art will appreciate that this embodiment still confers a substantial benefit over current solutions, as while the activation data (or ‘spikes’) must be written to and read from memory, the weights associated with each layer do not—they remain stationary, coded as the resistance of given delay paths. This contrasts with conventional architectures, in which the weights associated with a given layer would also need to be written to and read from memory when executing a new neuron on the same hardware instance.

According to one example of this further embodiment, neuron 105f and 105h may be the same neuron. In such an example, a given neuron—such as 105h—may fire, in response to an input signal. The pulse fired from 105h may then be passed through an output such that it is then transmitted through one of the variable delay paths shown in FIG. 5—such as through variable resistor 501. A second output pulse may then be fired from neuron 105h, in response to this input, and the second output pulse may be similarly passed through a feedback loop circuit such that it passes through the variable delay path containing variable resistor 502. The skilled person will appreciate that this process may repeat a variable number of times, depending on the number of input paths.

This architecture offers a significant increase in neural network implementation capacity with only a modest increase in the area usage due to the relatively high density of the NVRAM cells. The skilled person will appreciate that while three different pathways are shown in FIG. 5, this is provided by way of example and not limitation, and that other numbers of pathways may be used. 5

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A spiking neural network apparatus comprising a plurality of neurons, each neuron of the plurality of neurons having an input comprising a plurality of variable delay paths, and wherein each neuron of the plurality of neurons comprises:
one or more logic components connected to the plurality of delay paths, the logic component configured to generate an output signal in dependence upon signals received along the variable delay paths;
a timing component configured to determine a timing value in response to receiving the output signal from the one or more logic components; and
an accumulate component configured to accumulate a value based on one or more determined timing values from the timing component, wherein each neuron is configured to generate an output signal in a case that a value accumulated at the accumulate component reaches a threshold value.

2. The spiking neural network apparatus according to claim 1, wherein each variable delay path comprises at least one of: an inverter, a capacitor, and a variable resistor.

3. The spiking neural network apparatus according to claim 2, comprising at least one variable resistor that is a non-volatile RAM device, comprising at least one of:
a resistive RAM device;
a correlated-electron RAM device; and
a ferroelectric RAM device.

4. The spiking neural network apparatus according to claim 1, wherein the at least one logic component comprises a NAND gate.

5. The spiking neural network apparatus according to claim 1, wherein the timing component comprises a flip-flop connected to a timing signal line.

6. The spiking neural network apparatus according to claim 1, wherein the timing component is configured to reset a timing value at the start of an epoch.

7. The spiking neural network apparatus according to claim 1, wherein the accumulator component is configured to reset at the start of any epoch.

8. The spiking neural network apparatus according to claim 1, wherein the timing component is configured to determine a timing value that is in a gray code cyclic format.

9. The spiking neural network apparatus according to claim 2, wherein each variable delay path of the plurality of variable delay paths further comprises a plurality of variable resistors arranged in parallel and at least one pass transistor connected in series with each variable resistor.

10. The spiking neural network apparatus according to claim 9, wherein the at least one pass transistor is configured to receive a phase signal associated with a different portion of a dataflow graph of a neural network.

11. The spiking neural network apparatus according to claim 10, wherein the output signal generated by at least one neuron of the plurality of neurons is stored in a memory element of the spiking neural network apparatus, the memory element configured to store the output signal so that the output signal can be released along a variable delay path of the plurality of variable delay paths at a later time.

12. The spiking neural network according to claim 9, wherein the output signal generated by at least one neuron of the plurality of neurons is transmitted along a variable delay path of the plurality of variable delay paths to arrive at the logic component of the same neuron.

13. A method of training a neural network on a spiking neural network apparatus, the method comprising:
presenting a spiking neural network apparatus with test input data;
selecting, a single neuron from a first layer of the network;
defining a set of neurons from the first layer as sleeper neurons, which set of neurons does not include the selected neuron;
determining whether the selected neuron has an activation state that is in conformity with an expected output of the neural network; and
adjusting a delay value of at least one input variable delay path that inputs to the selected neuron.

14. The method according to claim 13, wherein adjusting the delay value of the variable delay path associated with the selected neuron associated with the selected neuron comprises:
identifying a sleeper neuron among the sleeper neurons that has an accumulated value that is closest to becoming activated or closest to becoming deactivated;
defining a difference between an accumulated value for the selected neuron and the accumulated value for the identified sleeper neuron;
determining differences by making small changes to delay values on each input delay path to the selected neuron; and
adjusting the delay value of at least one input variable delay path to the selected neuron based at least in part on the determined differences.

15. The method according to claim 14 wherein adjusting the delay value comprises one of:
reducing the delay value of the associated variable delay path by reducing the resistance value of the at least one variable resistor within the variable delay path; and
increasing the delay value of the associated variable delay path by increasing the resistance value of the at least one variable resistor within the variable delay path.

16. The method according to claim 14, wherein adjusting the delay value further comprises adjusting the delay value of at least one additional input variable delay path according to a dither pattern.

17. The method according to claim 13, wherein selecting a single neuron from the first layer of the network comprises one of selecting a neuron at random and selecting a neuron according to a predetermined search pattern.

18. A method of executing neural network data using a spiking neural network apparatus, the method comprising:
presenting the spiking neural network apparatus with data to be processed;
generating an input signal based on the data to be processed;
processing the input signal through the spiking neural network including, for a plurality of neurons, the steps of:
sending spike signals along a plurality of delay paths of the input of the plurality of neurons,
a logic component of each neuron generating an output signal in dependence upon the spike signals received along the variable delay paths,
a timing component of each neuron determining a timing value in response to receiving an output signal from the one or more logical components, and
an accumulate component of each neuron accumulating a value based on one or more determined timing values, and
generating an output signal in a case that the value accumulated at the neuron reaches a threshold value.
